(19) United States
(12) Patent Application Publication
(10) Pub. No.: US 2007/0162972 A1
(43) Pub. Date: Jul. 12, 2007

(54) Apparatus and method for processing of security capabilities through in-field upgrades

(75) Inventors: Teewoon Tan, Roseville (AU); Simon Ratner, Kensington (AU); Darren Williams, Newtown (AU); Stephen Gould, Queens Park (AU); Robert Matthew Barrie, Double Bay (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sensory Networks, Inc., Palo Alto, CA (US)

(21) Appl. No.: 11/330,973

(22) Filed: Jan. 11, 2006

(51) Int. Cl. G06F 12/14

(52) U.S. Cl. 726/22

(57) ABSTRACT

A method for upgrading one or more security applications, e.g., anti-spam, anti-virus, intrusion detection/prevention. The method includes deriving a second hardware logic from a security knowledge base. The method includes operating a computing system including a security device. The computer system is coupled to the one or more computer networks, e.g., local area networks, wide area networks, Internet. The security device has one or more security logic processors, which include one or more respective first hardware logic. The method transfers an FPGA image representative of at least the second hardware logic through the computer network to one or more first memory devices. The method includes temporarily halting one or more of the security logic processors at a predetermined portion of the stream of information according to a specific embodiment. The method includes loading the second hardware logic onto the one or more security logic processors while the one or more security logic processors have been paused. The method resumes the operation of the one or more security logic processors.

### BACKGROUND OF THE INVENTION

The present invention relates generally to computer networking security applications. More particularly, the invention provides a method and system for upgrading one or more hardware logic to one or more security logic processors coupled to a security device provided in a computing system in computer network environment. Merely by way of example, the invention has been applied to networking devices, which are distributed throughout local, wide area, and world wide area networks, any combination of these, and the like. Such networking devices include computers, servers, routers, bridges, network security appliances, firewalls, switches, any combination of these, and the like.

As the world progresses, internetworking of computers has become an important infrastructure for enterprises, communication systems, countries and the world. The data flowing between computers is increasingly more important in terms of both the content carried and the timeliness of delivery. Through technological advances in computing and networking, large databases are now in use and shared over networks by parties on opposite sides of the globe.

Data carried between computers across networks, such as the Internet, in small quantities are usually known as packets. Where an amount of data is too big to fit into a single packet (the size of which is typically defined by the characteristics of the network over which the packet will flow), a series of packets is used to carry the data from one end of the communication channel to the other. This series, or stream as it is commonly referred to, is then reassembled from the individual packets into the original data at the receiving end.

Packets are routed between computers using specially developed algorithms that allow computers and network equipment to decide along which path the packet should be sent to arrive at its final destination. These algorithms examine the packet header (typically a fixed sized portion of the packet containing information such as the source and destination address of the packet added to the payload to be transported) to make routing decisions. The algorithms need to examine the packet and make the decision very quickly to allow large numbers of packets to be sent with very small delay. As well as examining the header, the contents of the packet may be examined for information to aid in making decisions about the path and priority given to a packet; this examination of the data however adds an overhead that can limit the throughput and delay imposed by the device examining the data—typically the more data to be searched the longer the delay incurred by searching it.

Increasingly, as packets are sent from their source to their destination they are examined not just to help in routing decisions but for other purposes as well. A piece of email, which is sent across a network as a series of packets may be reassembled from the series of packets and examined to see if it is an unsolicited email message (commonly referred to as ‘spam’); this examination process often involves looking at the contents of the message, which is the payload portion of the packets involved in carrying the email. Similarly the email may be scanned to see if it contains a computer virus. Packets, or content data derived from a series of packets, may also be examined to look for copyright infringements, illegal activity such as network intrusions, spying, computer ‘hacking’ or corporate espionage, or simply to analyze usage to offer a better quality of service. By examining packets, or content data obtained from reassembling a series of packets, in a network new applications are now being offered, and it can reasonably be expected that new network applications based on the examination of packets or content data will continue to be developed.

Specialized network equipment is able to examine packet headers (with their small total size, set protocol and fixed layout) very quickly. However, to examine a packet's payload data or the content data derived from a series of packets, where content data are not always well structured, is complex and can be hard to do in the small window of time available to process each packet or content data. This problem is compounded when one must often analyze this payload or content data in context of data structures and protocols, and even further in the face of malicious obfuscation by a sophisticated attacker. Typically appliances such as email gateways, intrusion detection systems and general content protection appliances search the network data in software which, while often flexible and highly optimized, still comes nowhere near approaching the desired speeds, in terms of total throughput or delay. Appliances may also use specialized routing hardware which is strictly limited to examining headers. Furthermore, these software and hardware appliances typically impose quite severe restrictions on what data can be searched for, and the number of different patterns that can be matched simultaneously. Additionally, the software and hardware appliances often cannot uncover and detect security violations that occur in the network environment.

Specifically, the ability to detect existing and new security threats is often central to all network security systems. Detecting existing threats relies on pre-existing knowledge of the mechanism of action of a particular attack or malicious software. This knowledge usually takes the form of a signature that uniquely identifies the threat. As new threats are discovered, their signatures are distributed to existing security devices. Unfortunately, various limitations exist with these approaches.

As an example, a limitation of this approach is the inability of the security systems to detect previously unknown security threats. New attacks may often not yield to the same analysis techniques used to extract signatures from attacks in existence at the time the system was deployed. Alternatively, the signature definition format may not be sufficiently expressive to cover the new forms of security threats, requiring deployed security systems to be upgraded before these new threats can be detected. In the case of security systems based on hardware security devices, such in-field upgrades are often costly or impractical. That is, it is very difficult to upgrade conventional hardware security devices in an easy and cost effective manner. These and other limitations of the conventional approach can be found throughout the present specification and more particularly below.

What is desired is an apparatus and method that can improve detection of security. intrusions on computer networks.

### BRIEF SUMMARY OF THE INVENTION

According to the present invention, techniques for computer networking security applications are provided. More particularly, the invention provides a method and system for upgrading one or more hardware logic to one or more security logic processors coupled to a security device provided in a computing system in computer network environment. Merely by way of example, the invention has been applied to networking devices, which have been distributed throughout local, wide area, and world wide area networks, any combination of these, and the like. Such networking devices include computers, servers, routers, bridges, firewalls, network security appliances, any combination of these, and the like.

In a specific embodiment, the present invention provides software and hardware logic to be updated after it has been installed in its normal operating environment. The system is adapted to facilitate the upgrading of software and hardware logic in the field. The system includes a hardware logic provider, a computing system, a security device, transmission media, transmission sources, transmission destinations and security knowledge base. Computing system includes a computing system update controller, an optional first processing system and an optional second processing system. Security device includes a hardware logic update controller and one or more security logic processors.

In a specific embodiment, the present invention provides a method for upgrading one or more security applications, e.g., anti-spam, anti-virus, anti-spyware, intrusion detection/prevention. The method includes deriving a second hardware logic from a security knowledge base, e.g., database, library. The method includes operating a computing system (e.g., router, bridge, personal computer, server, network appliance, storage device, firewall) including a security device. The computing system is coupled to the one or more computer networks, e.g., local area networks, wide area networks, Internet. The security device has one or more security logic processors, which include one or more respective first hardware logic. The method transfers a field programmable gate array (“FPGA”) image representative of at least the second hardware logic through the computer network to one or more first memory devices. The method includes temporarily halting one or more of the security logic processors at a predetermined portion of the stream of information according to a specific embodiment. The method includes loading the second hardware logic onto the one or more security logic processors while the one or more security logic processors have been paused. The method resumes the operation of the one or more security logic processors.

In an alternative specific embodiment, the invention provides an alternative method for upgrading one or more security applications, e.g., anti-spam, anti-virus, anti-spyware, intrusion detection/prevention. The method includes providing a computing system (e.g., router, bridge, personal computer, server, network appliance, storage device, firewall) coupled to one or more computer networks (e.g., local area networks, wide area networks, Internet), where the computing system comprises a central processing unit that has been adapted to oversee one or more instructions associated with the computing system, a common bus coupled to the central processing unit, one or more first memory devices coupled to the common bus, a security device coupled to the common bus, one or more second memory devices coupled to the security device, and one or more security logic processors coupled to the security device. The security device is coupled to an input/output port coupled to the one or more computer networks. The security device is adapted to process a stream of information derived from the input/output port to perform a pattern matching process on one or more portions of the stream of information at about network speed. The one or more security logic processors have one or more respective first hardware logic. The method includes operating the computing system including the security device coupled to the one or more computer networks. The method includes transferring a field programmable gate array (“FPGA”) image representative of at least a second hardware logic through the computer network to the one or more first memory devices. The method includes pausing one or more of the security logic processors at a predetermined portion of the stream of information. The method loads the second hardware logic onto the one or more security logic processors while the one or more security logic processors have been paused.

In a specific embodiment, the present invention provides a system for upgrading one or more security applications. The system has one or more computer memories, where the one or more computer memories include at least one or more codes directed to operating a computing system including a security device, the computer system being coupled to the one or more computer networks (e.g., local area networks, wide area networks, Internet), the security device comprising one or more security logic processors, and the one or more security logic processors comprising one or more respective first hardware logic. The one or more computer memories also include at least one or more codes directed to transferring an FPGA image representative of at least the second hardware logic through the computer network to one or more first memory devices, where the one or more first memory devices is provided in the computing system. The one or more first memory devices also store at least one or more codes directed to pausing one or more of the security logic processors at a predetermined portion of the stream of information. The one or more computer memories also include at least one or more codes directed to loading the second hardware logic onto the one or more security logic processors while the one or more security logic processors have been paused. The one or more computer memories also include at least one or more codes directed to resuming the operation of the one or more security logic processors.

In an alternative specific embodiment, the present invention provides a system with one or more computer memories, where the one or more computer memories further include at least one or more codes directed to operating a first processing system provided in the computing system, where the first processing system comprises a first software logic. The one or more computer memories also include at least one or more codes directed to operating a second processing system provided in the computing system, where the second processing system comprises a third software logic. The one or more computer memories also include at least one or more codes directed to loading a second software logic onto the first processing system to replace at least in part the first software logic. The one or more computer memories also include at least one or more codes directed to loading a fourth software logic onto the second processing system to replace at least in part the third software logic.

In a specific embodiment, hardware logic to one or more security logic processors is derived from a collection of rules, signatures, patterns and instructions, which are in turn derivable from security knowledge base characterizing e-mail viruses, http viruses, spam e-mails, spywares, Web services attacks including those affecting Extensible Markup Language (XML) data, voice-over-IP attacks, intrusion attacks, encryption algorithms, decryption algorithms, combinations of these, and the like. In a further embodiment, hardware logic to one or more security logic processors is derived from a collection of representations of regular expressions characterizing unique properties of e-mail viruses, http viruses, spam e-mails, spywares, Web services attacks including those affecting Extensible Markup Language (XML) data, voice-over-IP attacks, and intrusion attacks. Of course, there can be other variations, modifications, and alternatives.

Numerous benefits and/or advantages can be performed using the present invention over conventional techniques. In a specific embodiment, the present invention can be implemented using conventional computer hardware and/or software. Additionally, the invention provides a method and apparatus that enables easy upgrading of security devices provided on computing applications in a remote manner. In a preferred embodiment, hardware logic can be updated remotely in an easy and cost effective manner. One or more of these benefits may be included in one or more of the embodiments described herein. These and other benefits are described throughout the present specification and more particularly below.

### BRIEF DESCRIPTION OF THE DRAWINGS

FIG. 1 is a simplified diagram of a system for upgrading the hardware logic in a security device according to an embodiment of the present invention;

FIG. 2A is a simplified high-level block diagram of a system for delivering security threat handling capabilities through in-field hardware upgrades according to an embodiment of the present invention.

FIG. 2B is a simplified high-level block diagram of a system for delivering security threat handling capabilities through in-field hardware upgrades according to an embodiment of the present invention.

FIG. 3A shows simplified functional blocks of the hardware logic provider, computing system update controller, hardware logic update controller and security logic processor according to an embodiment of the present invention.

FIG. 3B shows simplified functional blocks of the hardware logic provider, computing system update controller, hardware logic update controller and security logic processor according to an embodiment of the present invention.

FIG. 4 shows simplified functional blocks of the first/second hardware logic in FIGS. 3A and 3B in relation to security attributes stored in second memory devices and in accordance with an embodiment of the present invention.

FIG. 5 shows various functional blocks of the first/second hardware logic in FIGS. 3A and 3B in relation to the hardware logic update controller and in accordance with an embodiment of the present invention.

FIG. 6 is a flowchart of the steps carried out in the processing channels of FIGS. 4 and 5, in accordance with an embodiment of the present invention.

FIG. 7 is a simplified method for upgrading security applications according to an embodiment of the present invention, where the computing device includes a first processing system and a second processing system.

FIG. 8 is a simplified method for upgrading security applications according to an embodiment of the present invention, where the security logic processor processes data received from a second transmission medium and outputs data to a third transmission medium.

### DETAILED DESCRIPTION OF THE INVENTION

According to the present invention, techniques for computer networking security applications are provided. More particularly, the invention provides a method and system for upgrading one or more hardware logic to one or more security logic processors coupled to a security device provided in a computing system in computer network environment. Merely by way of example, the invention has been applied to networking devices that are distributed throughout local, wide area, and world wide area networks, any combination of these, and the like. Such networking devices include computers, servers, routers, bridges, firewalls, network security appliances, any combination of these, and the like.

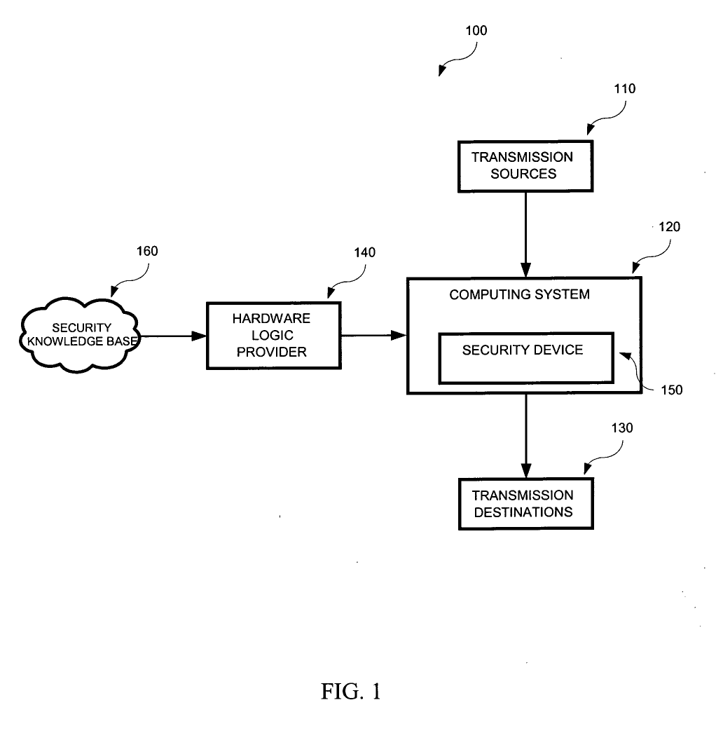

In a specific embodiment, the present invention enables security hardware to be updated after it has been installed in its normal operating environment. FIG. 1 is a simplified high-level diagram of a system 100 adapted to facilitate the upgrading of hardware logic of a security device in the field. This diagram is merely an example, which should not unduly limit the scope of the claims herein. One of ordinary skill in the art would recognize other variations, modifications, and alternatives. System 100 is shown as including a hardware logic provider 140, computing system 120, security device 150, transmission sources 110, transmission destinations 130 and security knowledge base 160. In a specific embodiment, the security knowledge base can be provided on a database platform such as those manufactured by Oracle Corporation, Microsoft Corporation, and other companies. As merely an example, the security knowledge base includes collections of information on known electronic message and data viruses maintained by anti-virus application vendors, collections of information on known spam techniques maintained by anti-spam application vendors, collections of information on known spyware techniques maintained by anti-spyware application vendors, collections of information on encryption algorithms, collections of information on decryption algorithms, collections of information on known network intrusion and attack techniques maintained by network security application vendors, information and data that can be gathered using a computer connected to the Internet, information and data that can be gathered using honeypot computers connected to the Internet that are configured to collect malicious data and attacks from the network from which solutions and countermeasures can be derived and implemented using software and hardware logic, any combination of these, and the like. The security device 150 is coupled to the computing device 120. One or more input data streams are provided by transmission sources 110. In an embodiment, the one or more input data streams are provided to the computing system 120 via a coupling to a network of computers. Of course, there can be other variations, modifications, and alternatives.

In another embodiment, the one or more input data streams are provided to the security device 150 via a coupling of a network of computers. The computing system 120 comprising the security device 150 processes the one or more input data streams and provides one or more output data streams to transmission destinations 130. A first hardware logic provided in the security device 150 is used to process the one or more input data streams and output one or more output data streams. Hardware logic provider 140 derives a second hardware logic from one or more portions of security information derived from security knowledge base 160, where the hardware logic provider 140 is coupled to the security knowledge base 160 through at least a network of computers. Of course, there can be other variations, modifications, and alternatives.

Furthermore, the hardware logic provider 140 derives a second computing system logic from the second hardware logic. The computing system 120 retrieves the second computing system logic, which includes the second hardware logic, from the hardware logic provider 140. The computing system 120 derives the second hardware logic from the second computing system logic and provides it to the security device 150 in order to update the functionalities of the security device 150 by replacing at least the first hardware logic with the second hardware logic. The first and second hardware logic represents hardware architectures implementing processors for handling security threats. The second hardware logic represents an updated hardware architecture implementing one or more processors for handling security threats. In an embodiment, the security device 150 is provided at a second geographic region and the hardware logic provider 140 is provided at a first geographic region. As merely an example, the term computing system logic refers to one or more algorithms and procedures implemented using computer program codes that are designed to execute on a computing system, which is an ordinary meaning for such term. As merely an example, the term computer system logic is one or more binary executable programs or modules existing as files that can be loaded into the random access memory (RAM) of a computing system and executed to perform specific tasks, but can also be others. Additionally, the term hardware logic refers to one or more algorithms and procedures implemented using semiconductor circuitry, optical circuitry, quantum circuitry, any combination of these, and the like, which is an ordinary meaning of such term. As merely an example, the term hardware logic is one or more FPGA images that can be loaded into hardware devices and enable the hardware devices to perform specific tasks, but can also be others. Of course, there can be other variations, modifications, and alternatives.

In an embodiment, the security device 150 receives one or more first processed data streams, processes the one or more first processed data streams and produces one or more second processed data streams. In an embodiment, the security device 150 is a network security device, where the network security device is adapted to process network data packets received in the one or more first processed data streams. For example, the network security device is used to perform at least one form of anti-virus filtering, anti-spam filtering, anti-spyware filtering, network intrusion detection, network intrusion prevention, encryption, decryption, network data packet flow management, and network data packet prioritization. In another embodiment, the security device 150 is a content processing device, where the content processing device is adapted to process content data derived from at least one network data packet received in the one or more first processed data streams. For example, the content processing device is used to perform at least one form of anti-virus filtering, anti-spam filtering, anti-spyware filtering, network intrusion detection, network intrusion prevention, encryption, decryption, network data packet flow management, and network data packet prioritization, processing on Extensible Markup Language (XML) data, and processing on Voice-over-IP (VoIP) data. As merely an example, the content processor may be a Grand Prix Series Tarari Content Processor manufactured by Tarari Inc., an Octeon™ Network Services Processor manufactured by Cavium Networks, Britestream Security NIC manufactured by Britestream Networks, but can be others. Of course, there can be other variations, modifications, and alternatives. Further details of the present method and system can be found throughout the present specification and more particularly below.

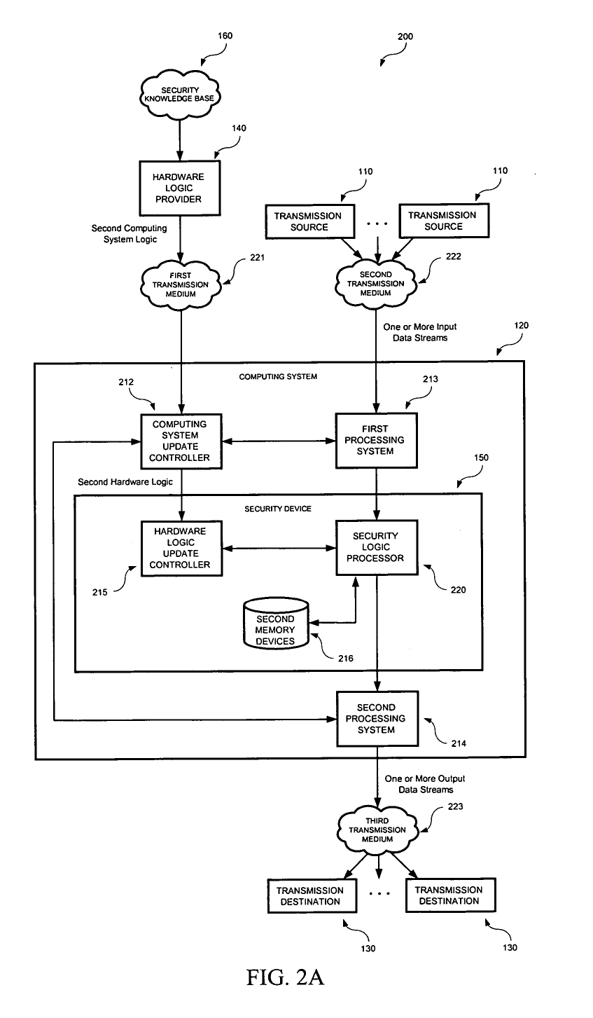

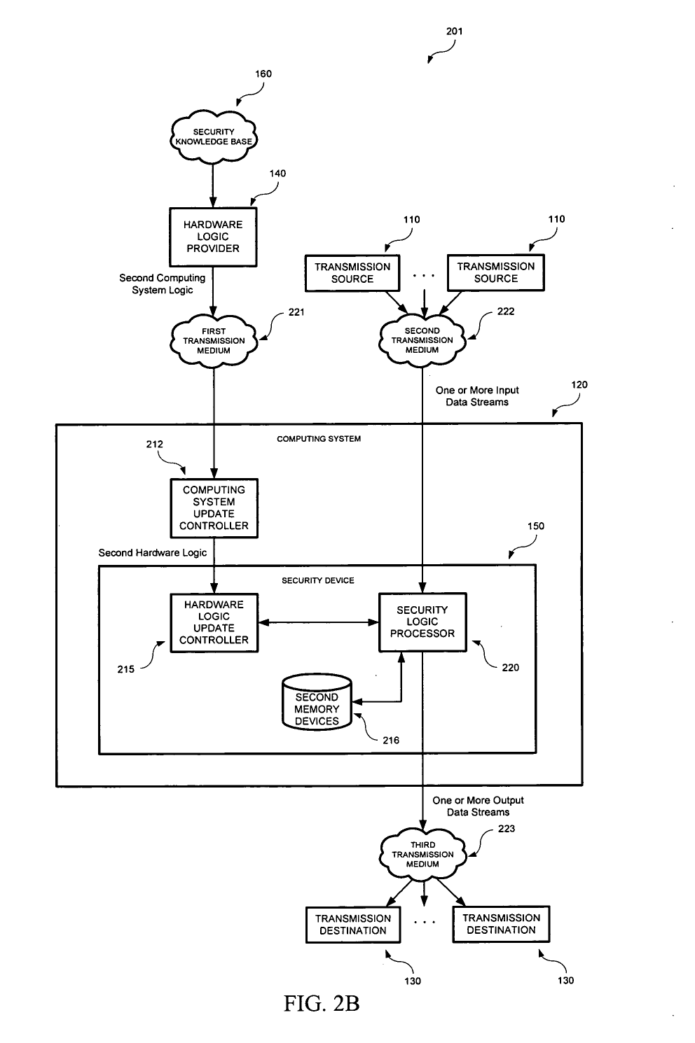

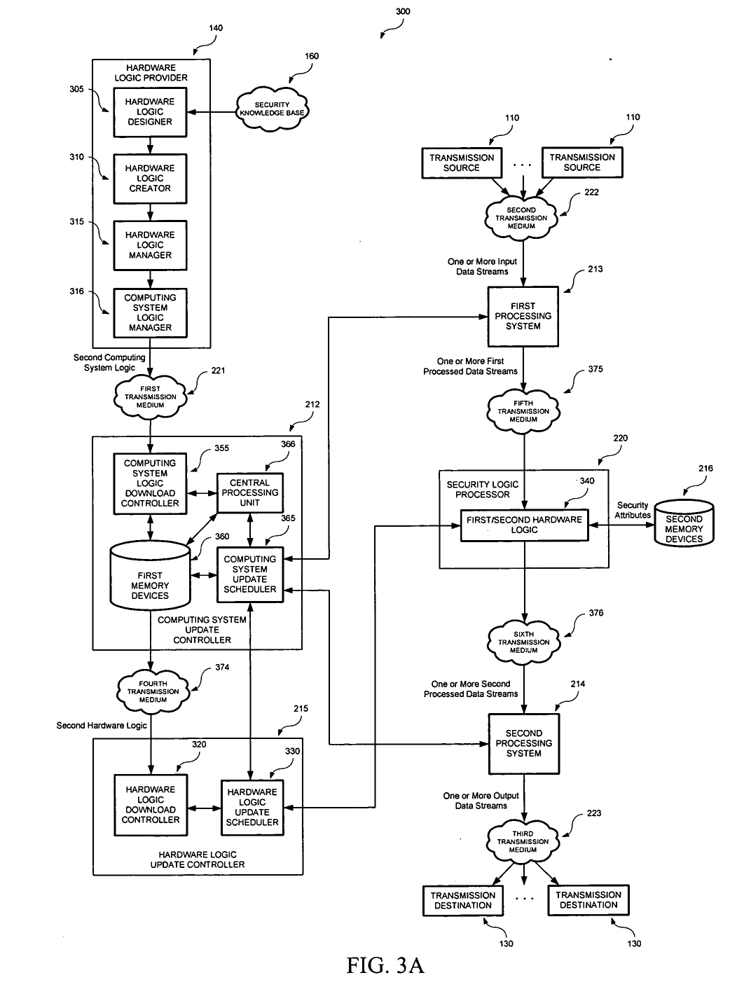

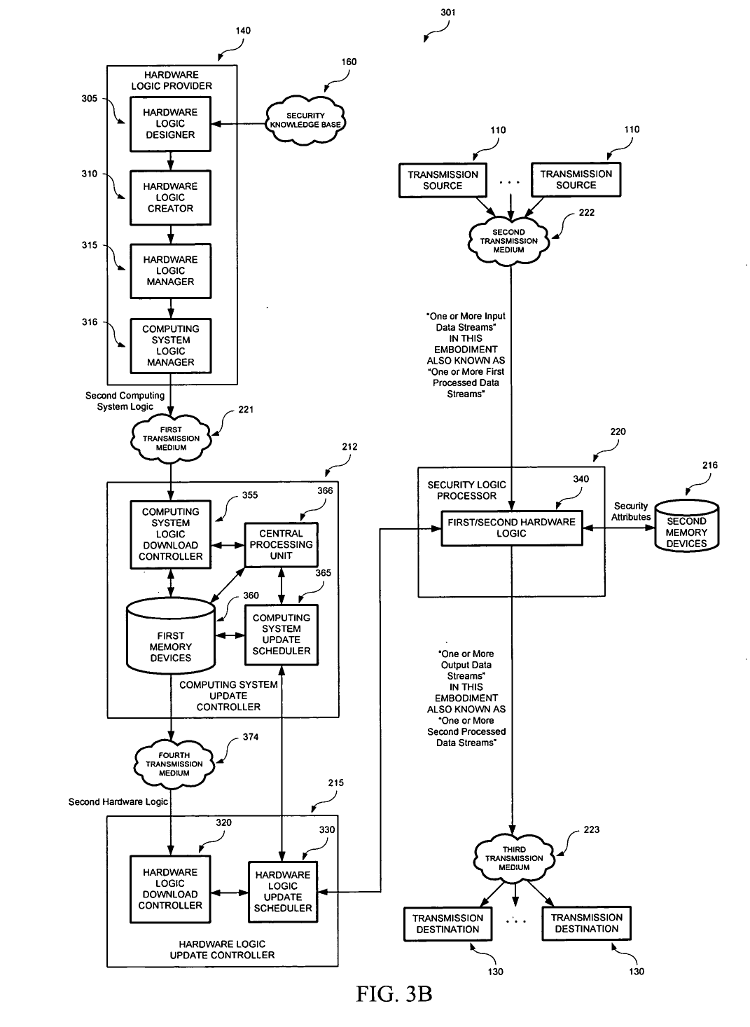

FIG. 2A is a simplified high-level diagram of a system 200 comprising a first embodiment of the computing system 120 and an embodiment of the security device 150. This diagram is merely an example, which should not unduly limit the scope of the claims herein. One of ordinary skill in the art would recognize other variations, modifications, and alternatives. The first embodiment of the computing system 120 is shown as including a computing system update controller 212, a first processing system 213, and a second processing system 214. In this embodiment, the computing system update controller 212 is adapted to receive the second computing system logic from the hardware logic provider 140 via a first transmission medium 221 provided in the network of computers. Furthermore, the computing system update controller 212 extracts the second hardware logic from the received second computing system logic, and transmits the extracted second hardware logic to the security device 150 via a fourth transmission medium 374 (shown in FIG. 3A). Of course, there can be other variations, modifications, and alternatives.

In a specific embodiment, the first processing system 213 provided in the first embodiment of the computing system 120 is adapted to receive one or more input data streams from one or more transmission sources. As an example, the information in the one or more input data streams is transmitted over a second transmission medium 222. The first processing system 213 processes the one or more input data streams to produce one or more first processed data streams. In an embodiment, first processing system 213 is a mail transfer agent (MTA), such as Postfix. In another embodiment, first processing system 213 comprises a mail transfer agent (MTA), such as Postfix, as well as a software processing module that processes e-mail messages from the MTA before outputting the processed data as one or more first processed data streams. The one or more first processed data streams are then transmitted to the security device 150. Of course, there can be other variations, modifications, and alternatives.

In a specific embodiment, the second processing system 214 provided in the first embodiment of the computing system 120 is adapted to receive one or more second processed data streams from the security device 150. The second processing system 214 then processes the one or more second processed data streams to produce one or more output data streams, which are then transmitted to one or more transmission destinations 130 via a third transmission medium 223 provided in the network of computers. In an embodiment, second processing system 214 accumulates and aggregates the results from the security device 150 prior to transmitting one or more output data streams to one or more transmission destinations 130 via a third transmission medium 223. In another embodiment, second processing system 214 is a mail transfer agent (MTA), such as Postfix. In a further embodiment, second processing system 214 is composed of a mail transfer agent (MTA), such as Postfix, as well as a software processing module that processes the results from the security device 150 before sending it to Postfix. Postfix then sends the resulting e-mail messages as one or more output data streams to one or more transmission destinations 130 via a third transmission medium 223. Of course, there can be other variations, modifications, and alternatives.

The illustrative embodiment of the security device 150 shown in FIG. 2A is shown as including a hardware logic update controller 215, security logic processor 220, and second memory devices 216. The hardware logic update controller 215 is adapted to receive the second hardware logic from the computing system 120. The received second hardware logic is then used to replace at least in part the first hardware logic in the security logic processor 220. The security logic processor 220 is adapted to receive one or more first processed data streams, process the one or more first processed data streams using the first or second hardware logic, and provide one or more second processed data streams. In an embodiment, the security logic processor 220 performs scanning and filtering on the one or more first processed data streams using one or more security attributes. One or more second memory devices 216 are used to store one or more security attributes, where the one or more security attributes are used by the security logic processor 220 during the processing of one or more first processed data streams to provide one or more second processed data streams. In one illustrative example, the one or more security attributes include regular expression rules that are used to detect spam messages.

An example of two security attributes used for detecting spam in messages are:

“buy a [degree|diploma|certificate] now!”

“V[ill]agra”

The above example illustrates how regular expressions can be used to detect text such as “buy a degree now!”, “buy a diploma now!”, “buy a certificate now!”, “Viagra”, “Vlagra”, or “Vlagra”. This example should not unduly limit the scope of the claims herein. One of ordinary skill in the art would recognize other variations, modifications, and alternatives that can be used as security attributes.

In an embodiment, one or more security logic processors 220 are coupled to the security device 150. In another embodiment, one or more second memory devices 216 are coupled to the security device 150 and the one or more security logic processors 220.

In an embodiment, the one or more first processed data streams received by the security device 150 are the same as the one or more input data streams, and the one or more second processed data streams outputted by the security device 150 are the same as the one or more output data streams that are transmitted to one or more transmission destinations 130 via a third transmission medium 223. This embodiment is used in conjunction with a second embodiment of the computing system 120, as shown in FIG. 2B. This diagram is merely an example, which should not unduly limit the scope of the claims herein. One of ordinary skill in the art would recognize other variations, modifications, and alternatives. The second embodiment of the computing system 120 comprises of computing system update controller 212. In this embodiment, the one or more input data streams are transmitted to the security device 150 without first being received, processed and outputted by the first processing system 213. Also in this embodiment, the one or more second processed data streams are transmitted as one or more output data streams to one or more transmission destinations 130 via a transmission medium 223 without first being received, processed and outputted by the second processing system 214.

In another embodiment, one or more input data streams are received by the security device 150 without first being received, processed and outputted by the first processing system 213, and the one or more second processed data streams produced by the security device 150 are transmitted to a second processing system 214. In another embodiment, one or more input data streams are first received by the first processing system 213, and the one or more second processed data streams produced by the security device 150 are transmitted as one or more output data streams to one or more transmission destinations 130 via a third transmission medium 223 without first being received, processed and outputted by second processing system 214.

In an embodiment, the security knowledge base 160 comprises a first information on network security. For example, the first information includes information on network intrusion methods. In this embodiment, the hardware logic provider 140 creates a first algorithm from the information on network intrusion methods and generates a second hardware logic that implements the first algorithm that can loaded into a security logic processor 220 to improve the detection and/or prevention of network intrusions. In another embodiment, the security knowledge base 160 comprises a second information on content security. For example, the second information includes information on XML exploitation methods. In this embodiment, the hardware logic provider 140 creates a second algorithm from the information on XML exploitation techniques and generates a second hardware logic that implements the second algorithm that can be loaded into a security logic processor 220 to improve the detection and/or prevention of XML exploits.

FIG. 3A is a simplified high-level diagram of a system 300 and is shown to include an embodiment of the hardware logic provider 140, computing system update controller 212 in the context of the first embodiment of the computing system 120, hardware logic update controller 215, and security logic processor 220. This diagram is merely an example, which should not unduly limit the scope of the claims herein. One of ordinary skill in the art would recognize other variations, modifications, and alternatives. This embodiment of the hardware logic provider 140 comprises a hardware logic designer 305, hardware logic creator 310, hardware logic manager 315 and computing system logic manager 316. The hardware logic designer 305 is adapted to receive one or more portions of the information from the security knowledge base 160, extract the desired information from the one or more portions of the information to form a second hardware logic design data. In a specific embodiment, relevant information from the security knowledge base 160 is extracted by the hardware logic designer 305 to produce an effective solution that addresses a security threat. For example, the hardware logic designer 305 receives information about network intrusion exploits from the security knowledge base 160. From the received information and knowledge, the hardware logic designer 305 creates an algorithm that can detect and prevent the respective network intrusion exploits. A design is then created from the algorithm and provided to the hardware logic creator 310 as second hardware logic design data. In an embodiment, hardware logic designer 305 is an automated system, such as one based on genetic algorithms. In another embodiment, hardware logic designer 305 is a human-assisted system. An example of a solution generated by hardware logic designer 305 that addresses a security threat is a finite state machine (FSM) designed to perform fast pattern matching, such as those disclosed in U.S. patent application No. US 2005/0035784 and U.S. patent application No. US 2005/0028114.

In a specific embodiment, the solution generated by hardware logic designer 305 may also include design data for a second software logic for a first processing system 213 and a fourth software logic for a second processing system 214. The hardware logic creator 310 is coupled to the hardware logic designer 305 and is adapted to receive the second hardware logic design data and also possibly a second and fourth software logic design data, from the hardware logic designer 305. The hardware logic creator 310 then forms the second hardware logic from the second hardware logic design data and also possibly a second and fourth software logic from the second and fourth software logic design data. For example, in an embodiment, based on the design data, the hardware logic creator 310 produces a second hardware logic representated by an FPGA image suited for a security logic processor 220. An example of the FPGA image is a hardware logic representation created by a Xilinx compiler targeted at a specific Xilinx part, but can be others. In another example, the FPGA image is represented by a bitstream file that can be loaded into a corresponding Xilinx part by an appropriate bitstream loader, but can be others.

In another embodiment, based on the design data, the hardware logic creator 310 produces a second software logic that performs data normalization in software and a fourth software logic that performs extra pattern matching on the results received from the security device 150. The hardware logic manager 315 is coupled to the hardware logic creator 310 and is adapted to receive the second hardware logic as well as possibly the second and fourth software logic, provided by the hardware logic creator 310. The hardware logic manager 315 is adapted to process the second hardware logic as well as possibly the second and fourth software logic. For example, in an embodiment, the hardware logic manager 315 adds the received second hardware logic into a database of second hardware logics and also possibly adds the received second and fourth software logic into a database of software logics. Access to the database of second hardware logics and also possibly the database of software logics, is then controlled by the hardware logic manager 315. The database of second hardware logics and also possibly the database of software logics may also include the use of primary and secondary storage devices. One example of a primary storage device includes the random access memory (RAM) of a computer. One example of a secondary storage device includes the hard disk drive of a computer. In another example of an embodiment of the hardware logic manager 315, the hardware logic manager 315 stores the received second hardware logic and also possibly the received second and fourth software logic, in at least one secondary storage device.

The computing system logic manager 316 is coupled to the hardware logic manager 315 and is adapted to receive second hardware logic and also possibly second and fourth software logic from hardware logic manager 315. The computing system logic manager 316 is further adapted to form the second computing system logic that includes the second hardware logic and also possibly the second and fourth software logic. The computing system logic manager 316 then processes the second computing system logic and provides access to the second computing system logic by a computing system update controller 212 via a first transmission medium 221.

As merely an example, in an embodiment, the computing system logic manager 316 derives a second computing system logic from the received second hardware logic, where the second computing system logic is representative of a software package of data that includes the second hardware logic, where the software package of data encapsulates the second hardware logic in a format that is convenient and suited for transmission over the first transmission medium 221, where in an embodiment, the first transmission medium 221 includes the Internet. In a further embodiment, the software package of data includes a second software logic to be loaded into the first processing system 213, and a fourth software logic to be loaded into the second processing system 214. In an embodiment, computing system logic manager 316 transmits second computing system logic including second hardware logic to computing system update controller 212 on demand and only sends second computing system logic that is compatible with computing system 120, where the second hardware logic included in second computing system logic is also compatible with security logic processor 220. In another embodiment, computing system logic manager 316 transmits second computing system logic including second hardware logic to computing system update controller 212 based on an automated update schedule and only sends second computing system logic that is compatible with computing system 120, where the second hardware logic included in second computing system logic is also compatible with security logic processor 220.

In an embodiment, the first processing system 213 is adapted to transmit the one or more first processed data streams to a security device 150 via a fifth transmission medium 375. In this embodiment, the one or more security logic processors 220 provided in the security device 150 are correspondingly adapted to receive one or more first processed data streams from the first processing system 213 via a fifth transmission medium 375. In an embodiment, the second processing system 214 is adapted to receive one or more second processed data streams from a security device 150 via a sixth transmission medium 376. In this embodiment, the one or more security logic processors 220 provided in the security device 150 are correspondingly adapted to produce one or more second processed data streams that are transmitted to the second processing system 214 via a sixth transmission medium 376.

In the simplified illustrative embodiment of the invention represented by FIG. 3A, computing system update control 212 is responsible for receiving second computing system logic from hardware logic provider 140 via a first transmission medium 221. The embodiment shown in FIG. 3A illustrates the computing system update controller 212 as comprising a computing system logic download controller 355, central processing unit 366, computing system update scheduler 365, and one or more first memory devices 360. In an embodiment, the computing system logic download controller 355 is adapted to receive the second computing system logic over a first transmission medium. The received second computing system logic is then stored in one or more first memory devices 360. The computing system logic download controller 355 is further adapted to derive a second hardware logic from the second computing system logic and stores the second hardware logic in the one or more first memory devices 360. The computing system logic download controller 355 is further adapted to derive a second and fourth software logic from the second computing system logic and stores the second and fourth software logic in the one or more first memory devices 360.

The first processing system 213 includes a first software logic for processing one or more input data streams. The computing system update scheduler 365 schedules a second determined time for updating at least in part the first software logic in the first processing system 213 with a second software logic. The operation of the first processing system 213 is controllable by the computing system update scheduler 365. The method of upgrading the first processing system 213 includes temporarily halting a first execution process o f the first processing system 213, upgrading the first software logic with at least a second software logic in the first processing system 213, and initiating execution of a second execution process of the first processing system 213 where the second execution process is associated with the second software logic and the second software logic is provided for processing one or more input data streams.

Furthermore, the computing system update scheduler 365 schedules a third determined time for updating at least in part the third software logic in the second processing system 214 with a fourth software logic. The operation of the second processing system 214 is controllable by the computing system update scheduler 365. The method of upgrading the second processing system 214 includes temporarily halting a third execution process of the second processing system 214, upgrading the third software logic with at least a fourth software logic in the second processing system 214, and initiating execution of a fourth execution process of the second processing system 214 where the fourth execution process is associated with the fourth software logic and the fourth software logic is provided for processing one or more second processed data streams.

The computing system update scheduler 365 is coupled to the hardware logic update scheduler 330 provided in the hardware logic update controller 215. In an embodiment, the computing system update scheduler 365 signals to hardware logic update scheduler 330 when an upgrade is taking place so that the hardware logic update scheduler 330 can perform the necessary steps to upgrade the security logic processor 220.

In a specific embodiment, the security logic processor 220 illustratively shown in FIG. 3A represents an embodiment of the invention where the security logic processor 220 comprises a first/second hardware logic 340. The hardware logic update controller 215 illustratively shown in FIG. 3A represents an embodiment of the invention where the hardware logic update controller 215 comprises a hardware logic download controller 320 and hardware logic update scheduler 330. The hardware logic download controller 320 receives second hardware logic from computing system update controller 212 via a fourth transmission medium 374. The hardware logic download controller 320 provides the second hardware logic to hardware logic update scheduler 330, which upgrades the hardware logic provided in one or more security logic processors 220. The computing system update scheduler 365 and hardware logic update scheduler 330 operate to schedule a determined time for updating the one or more security logic processors 220 of a security device 150.

In a specific embodiment, the operation of the one or more security logic processors 220 is controllable by the hardware logic update scheduler 330. The method of upgrading the hardware logic provided in the one or more security logic processors 220 include temporarily halting an execution process associated with a first hardware logic to be upgraded within the one or more security logic processors of the security device, the first hardware logic ceasing processing of the one or more first processed data streams during the temporarily halting step of the execution process, receiving the second hardware logic over a fourth transmission medium, updating the first hardware logic at least in part with the second hardware logic within the one or more security logic processors of the security device, and initiating execution of at least the second hardware logic within the one or more security logic processors of the security device to process one or more first processed data streams.

In an embodiment, the second hardware logic is stored in one or more memories, which are provided in a database. In another embodiment, the second hardware logic is managed within the database, for example, by storing a plurality of second hardware logic in a table indexed by an identifier and keeping the entries in the table up-to-date. In another embodiment, the second hardware logic provided by the hardware logic provider 140 is compatible with one or more security logic processors 220 of a security device 150. For example the second hardware logic provided by hardware logic provider 140 is targeted for an FPGA of a particular brand and model in a particular security device. In another embodiment, the second hardware logic is processed to verify its integrity has been preserved during the transfer from the hardware logic provider 140 to the computing system update controller 212. For example, the hardware logic provider 140 derives a first digital signature from the second hardware logic. The first digital signature and second hardware logic is then packaged into a second computing system logic.

In a specific embodiment, the second computing system logic, which includes the second hardware logic and first digital signature, is then transmitted to the computing system update controller 212. The computing system update controller 212, on receiving the second computing system logic, extracts the second hardware logic and first digital signature. The computing system update controller 212 then computes a second digital signature from the received second hardware logic, and compares the first digital signature to the second digital signature to verify that the second hardware logic has not been corrupted accidentally or purposefully by an attacker. In a further embodiment, the second hardware logic and/or second computing system logic is also encrypted.

In another embodiment, the second computing system logic provided by the hardware logic provider 140 is compatible with a computing system 120. For example the second computing system logic provided by hardware logic provider 140 is targeted for a computer with a particular CPU brand and model and with a particular operating system. In another embodiment, the second computing system logic is processed to verify that its integrity has been preserved during the transfer from the hardware logic provider 140 to the computing system update controller 212. For example, the hardware logic provider 140 derives a third digital signature from at least parts of the second computing system logic. The third digital signature is then packaged into a second computing system logic. The second computing system logic, which includes the third digital signature, is then transmitted to the computing system update controller 212. The computing system update controller 212, on receiving the second computing system logic, extracts the third digital signature. The computing system update controller 212 then computes a fourth digital signature from at least parts of the received second computing system logic, and compares the third digital signature to the fourth digital signature to verify that the second computing system logic has not been corrupted accidentally or purposefully by an attacker.

In an embodiment, computing system update scheduler 365 and hardware logic update scheduler 330 only schedules an update on the security logic processor 220 if a new, compatible and properly licensed second hardware logic is available. For example, if an end-user has not obtained a license for a second hardware logic, then hardware logic update scheduler 330 will not perform an update on the security logic processor 220 using that logic data. In a further embodiment, an update is only scheduled on the completion of the processing of a well-defined block of data received in the one or more first processed data streams. For example, a well-defined block of data is a packet of network traffic. In another example, a well-defined block of data is a complete e-mail message.

The computing system update scheduler 365 and hardware logic update scheduler 330 operate to coordinate the process of updating the security logic processor 220 to maintain the data and logical integrity of the various modules in the security logic processor 220. Data integrity within the security logic processor 220 refers to the integrity of the input and output data that enters and leaves the security logic processor 220. Without coordination and scheduling of hardware logic updates, it is possible to corrupt or lose input and output data when hardware logic updates are taking place. For example, if hardware logic update takes place whilst the security logic processor 220 is in the middle of processing input data and the reading of input data has not been temporarily halted, then the input data currently being processed by the security logic processor 220 will be lost or corrupted. Furthermore, since the hardware updating process takes a finite amount of time, input data received during the upgrade will also be lost or corrupted. Logical integrity within the security logic processor 220 refers to the integrity of the internal hardware logic. Without coordination and scheduling of hardware logic updates, it may be possible to corrupt the logics within the security logic processor 220, rendering it unusable. For example, without coordination and scheduling, incompatible hardware logic components can be loaded into the security logic processor 220, resulting in unpredictable behavior and unusable functionalities.

The computing system update scheduler 365 and hardware logic update scheduler 330 operate to resume the operation of the stopped first processing system 213, second processing system 214 and one or more security logic processors 220 in the correct sequence.

In the simplified illustrative embodiment of the invention represented by FIG. 3A, computing system update controller 212 is shown in the context of the first embodiment of the computing system 120, which includes a first processing system 213 and second processing system 214. The simplified illustrative embodiment of the invention represented by FIG. 3B is similar to the simplified illustrative embodiment of the invention shown in FIG. 3A with the exception that in FIG. 3B, the computing system update controller 212 is shown in the context of the second embodiment of the computing system 120, which does not include a first processing system 213 and a second processing system 214. In FIG. 3B, the one or more input data streams are transmitted to the security logic processor 220, so in this case, the one or more first processed data streams are in fact the same as the one or more input data streams. Also in FIG. 3B, the one or more second processed data streams are transmitted to the one or more transmission destinations 130 via a third transmission medium, so in this case, the one or more second processed data streams are in fact the same as the one or more output data streams.

In an embodiment, any of the first transmission medium 221, second transmission medium 222, third transmission medium 223, fourth transmission medium 374, fifth transmission medium 375 and sixth transmission medium 376 can be an Ethernet network, the Internet, and/or a data bus internal to a computer system. Transmission mediums include the use of physical mediums, such as a network cable. Transmission mediums also include wireless mediums, such as those that use electromagnetic radiation. In an embodiment, the computing system 120 and security device 150 is the same physical device. For example, the security device 150 is built into the motherboard of the computing system 120.

In a specific embodiment, the present invention provides a method for upgrading one or more security applications, e.g., anti-spam, anti-virus, anti-spyware, intrusion detection/prevention. The method includes deriving a second hardware logic from a security knowledge base, e.g., database, library. The method includes operating a computing system (e.g., router, bridge, personal computer, server, network appliance, storage device, firewall) including a security device. The computer system is coupled to the one or more computer networks, e.g., local area networks, wide area networks, Internet. The security device has one or more security logic processors, which include one or more respective first hardware logic. The method transfers an FPGA image representative of at least the second hardware logic through the computer network to one or more first memory devices. The method includes temporarily halting one or more of the security logic processors at a predetermined portion of the stream of information according to a specific embodiment. The method includes loading the second hardware logic onto the one or more security logic processors while the one or more security logic processors have been paused. The method resumes the operation of the one or more security logic processors. In an embodiment, the one or more first memory devices comprises a fixed storage device.

In an alternative specific embodiment, the invention provides an alternative method for upgrading one or more security applications, e.g., anti-spam, anti-virus, anti-spyware, intrusion detection/prevention. The method includes providing a computing system (e.g., router, bridge, personal computer, server, network appliance, storage device, firewall) coupled to one or more computer networks (e.g., local area networks, wide area networks, Internet), where the computing system comprises a central processing unit that has been adapted to oversee one or more instructions associated with the computing system, a common bus coupled to the central processing unit, one or more first memory devices coupled to the common bus, a security device coupled to the common bus, one or more second memory devices coupled to the security device, and one or more security logic processors coupled to the security device. In an embodiment, the common bus includes a PCI bus. The security device is coupled to an input/output port coupled to the one or more computer networks. The security device is adapted to process a stream of information derived from the input/output port to perform a pattern matching process on one or more portions of the stream of information at about network speed. In an embodiment, about network speed is at least one hundred Mega bits per second. The one or more security logic processors have one or more respective first hardware logic. The method includes operating the computing system including the security device coupled to the one or more computer networks. The method includes transferring an FPGA image representative of at least a second hardware logic through the computer network to the one or more first memory devices. The method includes pausing one or more of the security logic processors at a predetermined portion of the stream of information. The method loads the second hardware logic onto the one or more security logic processors while the one or more security logic processors have been paused.

In a specific embodiment, the present invention provides a system for upgrading one or more security applications. The system has one or more computer memories, where the one or more computer memories include at least one or more codes directed to operating a computing system including a security device, the computer system being coupled to the one or more computer networks (e.g., local area networks, wide area networks, Internet), the security device comprising one or more security logic processors, and the one or more security logic processors comprising one or more respective first hardware logic. The one or more computer memories also include at least one or more codes receiving to transferring an FPGA image representative of at least the second hardware logic through the computer network to one or more first memory devices, where the one or more first memory devices is provided in the computing system. The one or more first memory devices also store at least one or more codes directed to pausing one or more of the security logic processors at a predetermined portion of the stream of information. The one or more computer memories also include at least one or more codes directed to loading the second hardware logic onto the one or more security logic processors while the one or more security logic processors have been paused. The one or more computer memories also include at least one or more codes directed to resuming the operation of the one or more security logic processors.

In an alternative specific embodiment, the present invention provides a system with one or more computer memories, where the one or more computer memories further include at least one or more codes directed to operating a first processing system provided in the computing system, where the first processing system comprises a first software logic. The one or more computer memories also include at least one or more codes directed to operating a second processing system provided in the computing system, where the second processing system comprises a third software logic. The one or more computer memories also include at least one or more codes directed to loading a second software logic onto the first processing system to replace at least in part the first software logic. The one or more computer memories also include at least one or more codes directed to loading a fourth software logic onto the second processing system to replace at least in part the third software logic.

In a specific embodiment, hardware logic to one or more security logic processors are derived from a collection of signatures, rules, patterns and instructions, which are in turn derivable from security knowledge base characterizing e-mail viruses, http viruses, spam e-mails, spywares, Web services attacks including those affecting Extensible Markup Language (XML) data, voice-over-IP attacks, and intrusion attacks, combinations of these, and the like. In a further embodiment, hardware logic to one or more security logic processors are derived from a collection of representations of regular expressions characterizing unique properties of e-mail viruses, http viruses, spam e-mails, spywares, Web services attacks including those affecting Extensible Markup Language (XML) data, voice-over-IP attacks, and intrusion attacks. Of course, there can be other variations, modifications, and alternatives.

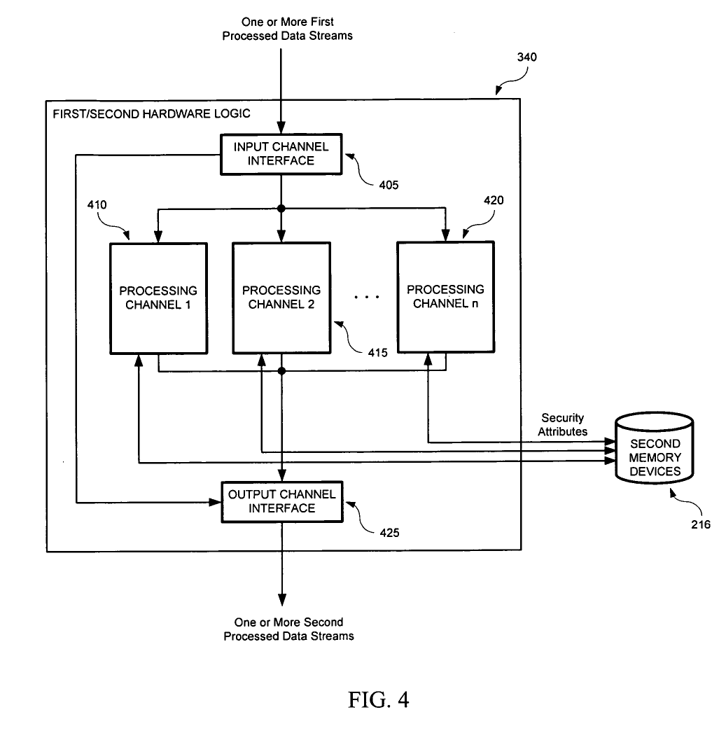

FIG. 4 shows a block diagram of the components of an embodiment of first/second hardware logic 340 in relation to security attributes provided in one or more second memory devices 216. In accordance with this embodiment, first/second hardware logic 340 is shown as including an input channel interface 405, processing channel 1 410, processing channel 2 415, processing channel n 420, and output channel interface 425. FIG. 4 illustrates the data flow from one or more first processed data streams through to the one or more second processed data streams in terms of the components of the first/second hardware logic 340. Also shown in FIG. 4 is the data flow between the components of first/second hardware logic 340 and security attributes provided in one or more second memory devices 216. In accordance with this embodiment, input channel interface 405 receives data from one or more first processed data streams. Input channel interface 405 redirects data from the received one or more first processed data streams into at least one of the n processing channels. Input channel interface 405 also provides the raw input data that has not been processed by the processing channels 410, 415, and 420 to output channel interface 425.

In accordance with an embodiment of the first/second hardware logic 340, processing channels 410, 415, and 420 perform security processing functions in parallel. Processing channels 410, 415, and 420 obtain input data from input channel interface 405 and processes them using security attributes provided in one or more second memory devices 216. In an embodiment, each processing channel 410, 415, and 420 implement different security processing functions. In a further embodiment, a plurality of processing channels 410, 415, or 420 implement a pattern matching system based on finite state machines, such as those disclosed in U.S. patent application No. US 2005/0035784 and U.S. patent application No. US 2005/0028114. The results of pattern matching in processing channels 410, 415, and 420 are then sent to output channel interface 425. As merely examples, patterning matching processes and systems are illustrated in U.S. Provisional Application 60/654224 filed Feb. 17, 2005 (Attorney Docket Number 021741-001910) and U.S. Application Serial Nos. 10/927967 filed Aug. 26, 2004,______, and ______ (Attorney Docket Numbers 021741-001600US, 021741-001910US, and 021741-001920US), commonly assigned, and hereby incorporated by reference for all purposes.

In accordance with an embodiment of the first/second hardware logic 340, output channel interface 425 accepts raw input data from input channel interface 405 as well as pattern matching results from processing channels 410, 415, and 420. Output channel interface 425 then transmits match results along with any raw input data as one or more second processed data streams.

In an embodiment, security attributes provided in one or more second memory devices 216 are a collection of rules, signatures, patterns and instructions derivable from security knowledge base 160 characterizing e-mail viruses, http viruses, spam e-mails, spywares, XML-based attacks, voice-over-IP attacks, and intrusion attacks. In a further embodiment, security attributes provided in one or more second memory devices 216 include a collection of representations of regular expressions characterizing unique properties of e-mail viruses, http viruses, spam e-mails, spywares, XML-based attacks, voice-over-IP attacks, and intrusion attacks. The regular expressions are then used by finite state machine pattern matching systems, such as those disclosed in U.S. patent application No. US 2005/0035784 and U.S. patent application No. US 2005/0028114, for matching against the incoming input data.

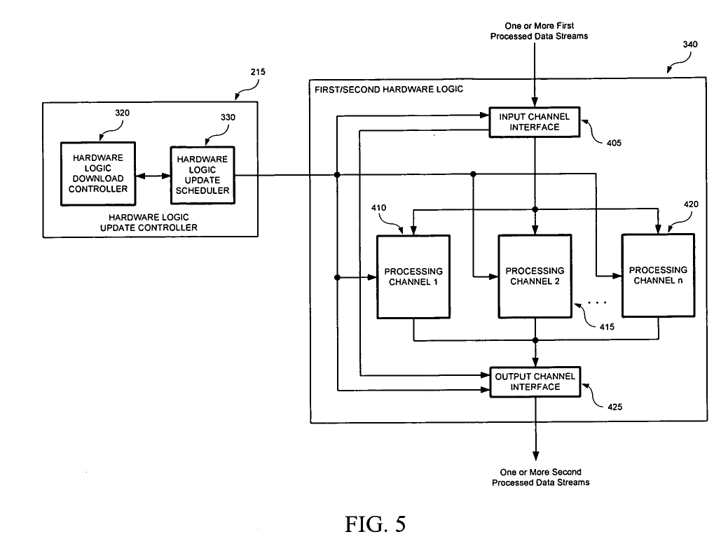

FIG. 5 shows a block diagram of the components of an embodiment of first/second hardware logic 340 in relation to the hardware logic update controller 215. In this embodiment, input channel interface 405, output channel interface 425, and processing channels 410, 415, and 420, operate as shown in the illustrative embodiment represented by FIG. 4. When a hardware logic update is scheduled by hardware logic update scheduler 330, a ‘stop’ signal is sent to input channel interface 405, output channel interface 425, and processing channels 410, 415, and 420. In an embodiment, all of these components stop processing at the earliest possible time, whilst maintaining their state prior to the stop operation. In another embodiment, hardware logic update scheduler 330 only sends ‘stop’ signals to those components that require updating. Other components continue to execute if it is possible to do so. For example, if processing channel 1 410 is the only component to be updated, then it is the only component that is temporarily stopped, with data from the input channel interface 405 being redirected to the other channels. All other components continue to execute as normal. Once the execution of the relevant components of first/second hardware logic 340, are temporarily stopped, hardware logic update scheduler 330 proceeds to update the relevant hardware components.

After updating the components of first/second hardware logic 340, hardware logic update scheduler 330 sends a ‘start’ signal to all components of first/second hardware logic 340 that have previously been stopped, thus restoring the components to their states prior to the stop operation. Processing then recommences in the stopped components, and execution proceeds as normal. Since security hardware updates occur relatively infrequently and hardware updates can be conducted in a timely manner, the effect of stopping processing while the update takes place should not significantly and adversely affect the throughput performance of the content security system.

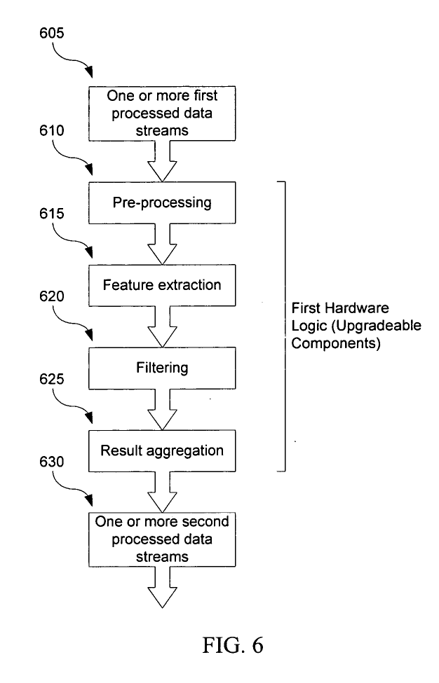

FIG. 6 is a flowchart of the processing functions implemented in an embodiment of the first/second hardware logic 340. The flowchart illustrates the distinct processing steps of receiving the one or more first processed data streams 605, pre-processing 610, feature extraction 615, filtering 620, result aggregation 625, and generation of one or more second processed data streams 630. The upgradeable hardware logic components perform the steps of pre-processing 610, feature extraction 615, filtering 620, and result aggregation 625. In an embodiment, pre-processing step 610 normalizes the input data. For example, uniform resource identifiers (URI) are normalized into a pre-determined format. In an embodiment, feature extraction step 615 extracts features from the pre-processed data. For example, the hash values of fragments of the pre-processed data are calculated and passed to the next step. In an embodiment, filtering step 620 performs pattern matching using security attributes provided in one or more second memory devices 216. Data passed to this step that matches any of the security attributes provided in one or more second memory devices 216 then raises signals that are passed to the next step along with any match information. In an embodiment, result aggregation step 625 accepts the matched patterns and accumulates a histogram of the patterns that matched. This histogram along with other match statistics is then outputted as one or more second processed data streams 630.

Security knowledge base 160 is a pool of knowledge concerning network and content security. For example, this pool can encompass the body of knowledge existing in the Internet, and public and private libraries of books, journals, conference proceedings, white papers, reports, presentations, formal and informal conversations, news articles, magazines and surveys existing in various formats, such as paper, electronic, CD, DVD, photographic and microfilm. This pool of knowledge can contain information such as known security exploits, signatures representing security exploits and methods for detecting and preventing such exploits.

The one or more transmission sources 110 contain data to be scanned by the computing system 120 comprising security device 150. Examples of transmission sources 110 include servers that send e-mail, servers that serve web-pages and computing machines that send data over a network. The one or more transmission sources 110 send data that could potentially carry information that is a security threat to computing system 120 and/or one or more transmission destinations 130. The one or more transmission destinations 130 are coupled to the one or more transmission sources 110.

A method for upgrading one or more security applications, e.g., anti-spam, anti-virus, intrusion detection/prevention in a networking environment is briefly outlined below:

1. Derive a second hardware logic from a security knowledge base, e.g., database;

2. Operate a computing system (e.g., router, bridge, personal computer, server, network appliance, storage device, firewall) including a security device;

3. Transfer an FPGA image representative of at least a second hardware logic through the computer network to one or more first memory devices, which is coupled to the computing system;

4. Temporarily halting one or more of the security logic processors at a predetermined portion of the stream of information;

5. Load the second hardware logic onto the one or more security logic processors while the one or more security logic processors have been paused;

6. Resume the operation of the one or more security logic processors; and

7. Perform other steps, as desired.

As shown, the above sequence of steps provides a method for upgrading one or more security applications operating with one or more network devices coupled to a computing system in a networking environment. Depending upon the embodiment, one or more of the steps can be combined. Other steps can be added according to specific embodiments. In yet other embodiments, certain steps may be removed. Of course, there can be other variations, modifications, and alternatives. Further details of the present method can be found through out the present specification and more particularly below.

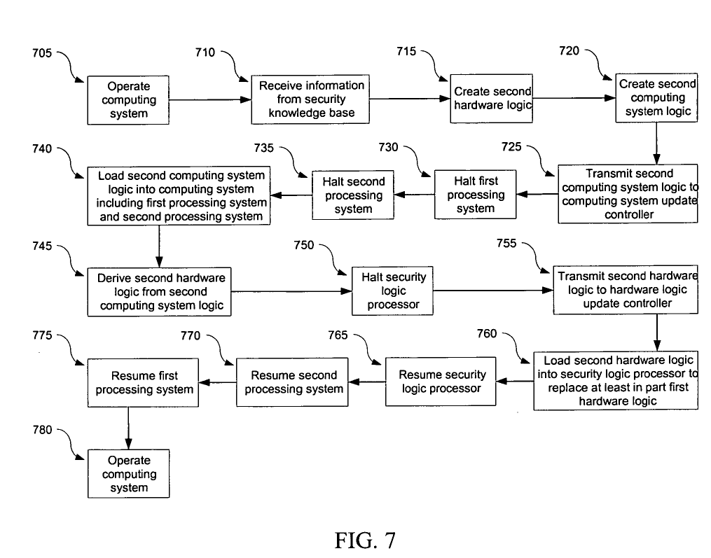

FIG. 7 is a simplified method for upgrading security applications according to an embodiment of the present invention. The steps to this method are briefly outlined below:

1. Operate the computing system (step 705);

2. Receive information from security knowledge base (step 710);

3. Derive a second hardware logic and possibly second and fourth software logic from the received information (step 715);

4. Derive a second computing system logic from the second hardware logic (step 720), where the second computing system logic may include a second software logic and a fourth software logic;

5. Transmit the second computing system logic to computing system update controller (step 725);

6. Halt processing in the first processing system (step 730);

7. Halt processing in the second processing system (step 735);

8. Load second computing system logic into computing system, where the second software logic is derived from the second computing system logic and used to replace at least in part the first software logic in the first processing system, and the fourth software logic is derived from the second computing system logic and used to replace at least in part the third software logic in the second processing system (step 740);

9. Derive the second hardware logic from the second computing system logic (step 745);

10. Halt processing in the security logic processor (step 750);

11. Transmit the second hardware logic to hardware logic update controller (step 755);

12. Load the second hardware logic into the security logic processor to replace at least in part the first hardware logic (step 760);

13. Resume processing in the security logic processor (step 765);

14. Resume processing in the second processing system (step 770);

15. Resume processing in the first processing system (step 775);

16. Operate the computing system (step 780).

As shown, the above sequence of steps provides a simplified method for upgrading security applications. Depending upon the embodiment, one or more of the steps can be combined. Other steps can be added according to specific embodiments. In yet other embodiments, certain steps may be removed. Of course, there can be other variations, modifications, and alternatives. Further details of the present method can be found through out the present specification and more particularly below.

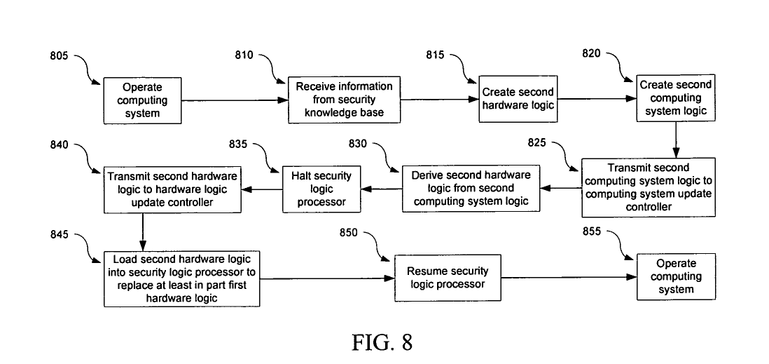

FIG. 8 is a simplified method for upgrading security applications according to an embodiment of the present invention. The steps to this method are briefly outlined below:

1. Operate the computing system (step 805);

2. Receive information from security knowledge base (step 810);

3. Derive a second hardware logic from the received information (step 815);

4. Derive a second computing system logic from the second hardware logic (step 820);

5. Transmit the second computing system logic to computing system update controller (step 825);

6. Derive the second hardware logic from the second computing system logic (step 830);

7. Halt processing in the security logic processor (step 835);

8Transmit the second hardware logic to hardware logic update controller (step 840);

9. Load the second hardware logic into the security logic processor to replace at least in part the first hardware logic (step 845);

10. Resume processing in the security logic processor (step 850);

11. Operate the computing system (step 855).

As shown, the above sequence of steps provides a simplified method for upgrading security applications. Depending upon the embodiment, one or more of the steps can be combined. Other steps can be added according to specific embodiments. In yet other embodiments, certain steps may be removed. Of course, there can be other variations, modifications, and alternatives.

Although the foregoing invention has been described in some detail for purposes of clarity and understanding, those skilled in the art will appreciate that various adaptations and modifications of the just-described preferred embodiments can be configured without departing from the scope and spirit of the invention. For example, other pattern matching technologies may be used, or different network topologies may be present. Moreover, the described data flow of this invention may be implemented within separate network systems, or in a single network system, and running either as separate applications or as a single application. Therefore, the described embodiments should not be limited to the details given herein, but should be defined by the following claims and their full scope of equivalents.

What is claimed is:

1. A system for field upgrading a hardware logic module of a security device operating in a computing system, the system comprising:
a security knowledge base, the security knowledge base comprising at least a library of security information;
a hardware logic provider coupled to the security knowledge base through at least a network of computers, the hardware logic provider being adapted to receive one or more portions of the security information derived from the security knowledge base; the hardware logic provider adapted to generate a second hardware logic derived from the one or more portions of the security information and adapted to generate a second computing system logic from the second hardware logic;
one or more computing systems coupled to the network of computers; and
a security device provided in the one or more computing systems, the security device comprising a first hardware logic, the security device being adapted to receive a second hardware logic derived from the second computing system logic, the second hardware logic being provided to replace at least the first hardware logic.

2. The system of claim 1 wherein the one or more computing systems is adapted to receive the second computing system logic from the hardware logic provider and is adapted to derive the second hardware logic from the second computing system logic.

3. The system of claim 1 wherein the security device is provided at a second geographic region and the hardware logic provider is provided at a first geographic region.

4. The system of claim 1 wherein the security device is further adapted to receive one or more first processed data streams, adapted to process the one or more first processed data streams using at least the second hardware logic and adapted to produce one or more second processed data streams.

5. The system of claim 4 wherein the security device is a network security device; the network security device being adapted to process network data packets received in the one or more first processed data streams.

6. The system of claim 5 wherein the network security device is further adapted to process network data packets including at least one of the operations of anti-virus filtering, anti-spam filtering, anti-spyware filtering, detecting network intrusions, preventing network intrusions, encrypting network data packets, decrypting network data packets, managing the flow of network data packets, prioritizing the flow of network data packets, and securing the flow of network data packets.

7. The system of claim 4 wherein the security device is a content processing device; the content processing device being adapted to process content data derived from at least one network data packet received in the one or more first processed data streams.

8. The system of claim 7 wherein the content processing device is further adapted to perform content data including at least one of the operations of anti-virus filtering, anti-spam filtering, anti-spyware filtering, detecting network intrusions, preventing network intrusions, encrypting content data, decrypting content data, managing the flow of content data, prioritizing the flow of content data, and securing the flow of content data.

9. The system of claim 7 wherein said content data comprises at least Extensible Markup Language (XML) data.

10. The system of claim 7 wherein said content data comprises at least Voice-over-IP (VoIP) data.

11. The system of claim 4 wherein said one or more first processed data streams are one or more input data streams from one or more transmission sources transmitted over a second transmission medium provided in the network of computers.

12. The system of claim 4 wherein said one or more second processed data streams are one or more output data streams that are transmitted to one or more transmission destinations via a third transmission medium provided in the network of computers.

13. The system of claim 2 wherein said computing system further comprises:
a computing system update controller adapted to receive the second computing system logic from the hardware logic provider transmitted over a first transmission medium provided in the network of computers; the computing system update controller being adapted to extract the second hardware logic from the second computing system logic; the computing system update controller being adapted to transmit the extracted second hardware logic to a security device via a fourth transmission medium;
a first processing system adapted to receive one or more input data streams from one or more transmission sources transmitted over a second transmission medium provided in the network of computers, adapted to process the one or more input data streams, adapted to provide one or more first processed data streams and adapted to transmit the one or more first processed data streams to a security device; and
a second processing system adapted to receive one or more second processed data streams from the security device, adapted to process the one or more second processed data streams, adapted to provide one or more output data streams and adapted to transmit the one or more output data streams to one or more transmission destinations via a third transmission medium provided in the network of computers.

14. The system of claim 1 wherein the security device further comprises:
a hardware logic update controller, the hardware logic update controller being adapted to receive the second hardware logic to replace the first hardware logic; the hardware logic update controller further adapted to replace at least in part the first hardware logic with the second hardware logic within one or more security logic processors.

15. The system of claim 14 wherein the one or more security logic processors adapted to receive one or more first processed data streams; the one or more security logic processors further comprising the second hardware logic to perform data processing; the second hardware logic being adapted to perform processing on the one or more first processed data streams; the one or more security logic processors being adapted to provide one or more second processed data streams.

16. The system of claim 15 wherein the security device further comprises:
one or second memory devices, the one or more second memory devices being coupled to the security logic processor; the one or more second memory devices being adapted to store one or more security attributes; the one or more security attributes being adapted for use by the security logic processor during the processing of one or more first processed data streams to provide one or more second processed data streams.

17. The system of claim 1 wherein the security knowledge base further comprises a first information on network security.

18. The system of claim 1 wherein the security knowledge base further comprises a second information on content security.

19. The system of claim 1 wherein the hardware logic provider further comprises:
a hardware logic designer adapted to receive one or more portions of the information from the security knowledge base; the hardware logic designer being adapted to extract desired information from the one or more portions of the information to form the second hardware logic design data;
a hardware logic creator coupled to the hardware logic designer, the hardware logic creator adapted to receive the second hardware logic design data from the hardware logic designer; the hardware logic creator being adapted to form the second hardware logic from the second hardware logic design data;
a hardware logic manager coupled to the hardware logic creator, the hardware logic manager being adapted to receive the second hardware logic provided by the hardware logic creator; the hardware logic manager being adapted to process the second hardware logic; and
a computing system logic manager coupled to the hardware logic manager, the computing system logic manager being adapted to receive the second hardware logic from hardware logic manager; the computing system logic manager being adapted to form the second computing system logic including the second hardware logic; the computing system logic manager being adapted to process the second computing system logic; the computing system logic manager being adapted to provide access to second computing system logic by a computing system update controller via a first transmission medium.

20. The system of claim 19 wherein the hardware logic designer is further adapted to form a second and fourth software logic design data.

21. The system of claim 20 wherein the hardware logic creator is further adapted to receive the second and fourth software logic design data; the hardware logic creator being adapted to form the second and fourth software logic from the second and fourth software logic design data.

22. The system of claim 21 wherein the hardware logic manager is further adapted to receive the second and fourth software logic provided by the hardware logic creator; the hardware logic manager being adapted to process the second and fourth software logic.

23. The system of claim 22 wherein the computing system logic manager is further adapted to receive the second and fourth software logic from hardware logic manager; the computing system logic manager being adapted to form the second computing system logic including the second and fourth software logic.

24. The system of claim 13 wherein said first processing system is further adapted to transmit the one or more first processed data streams to a security device via a fifth transmission medium.

25. The system of claim 13 wherein said second processing system is further adapted to receive one or more second processed data streams from a security device via a sixth transmission medium.

26. The system of claim 15 wherein said one or more security logic processors are further adapted to receive the one or more first processed data streams from a first processing system via a fifth transmission medium.

27. The system of claim 15 wherein said one or more security logic processors are further adapted to produce one or more second processed data streams that are transmitted to a second processing system via a sixth transmission medium.

28. A system of claim 13 wherein said transmission mediums include at least one of an Ethernet network, the Internet, and a database internal to a computer system.

29. A system of claim 26 wherein said transmission mediums include at least one of an Ethernet network, the Internet, and a database internal to a computer system.

30. The system of claim 1 wherein computing system and the security device is the same physical device.

31. A method for field upgrading hardware logic comprising:
extracting information from a security knowledge base;
generating a second hardware logic from the extracted information from the security knowledge base;
generating a second computing system logic from the second hardware logic;
transmitting the second computing system logic over a first transmission medium;
receiving the second computing system logic over a first transmission medium;
extracting the second hardware logic from the second computing system logic;
scheduling a determined time for updating one or more security logic processors of a security device;
temporarily halting an execution process associated with a first hardware logic to be upgraded within the one or more security logic processors of the security device, the first hardware logic ceasing processing of one or more first processed data streams during the temporarily halting step of the execution process;
receiving the second hardware logic over a fourth transmission medium;
updating the first hardware logic with the second hardware logic within the one or more security logic processors of the security device; and
initiating execution of at least the second hardware logic within the one or more security logic processors of the security device to process one or more first processed data streams.

32. The method of claim 31 further comprising:
extracting information from a security knowledge base;
generating a second software logic from the extracted information from the security knowledge base;
including the second software logic in a second computing system logic that includes a second hardware logic;
transmitting the second computing system logic over a first transmission medium;
receiving the second computing system logic over a first transmission medium;
extracting the second software logic from the second computing system logic;
scheduling a second determined time for updating a first processing system of a computing system, the computing system being coupled to the security device, the first processing system including a first software logic for processing one or more input data streams;
temporarily halting a first execution process of the first processing system within the computing system, the first processing system being provided with the first software logic;
upgrading the first software logic with at least a second software logic in the first processing system; and
initiating execution of a second execution process of the first processing system within the computing system, the second execution process being associated with the second software logic, the second software logic being provided for processing one or more input data streams.

33. The method of claim 31 further comprising:
extracting information from a security knowledge base;
generating a fourth software logic from the extracted information from the security knowledge base;
including the fourth software logic in a second computing system logic that includes a second hardware logic;
transmitting the second computing system logic over a first transmission medium;
receiving the second computing system logic over a first transmission medium;
extracting the fourth software logic from the second computing system logic;
scheduling a third determined time for updating a second processing system of a computing system, the computing system being coupled to the security device, the second processing system including a third software logic for processing one or more second processed data streams;
temporarily halting a third execution process of the second processing system within the computing system, the second processing system being provided with the third software logic;
upgrading the third software logic with at least a fourth software logic in the second processing system; and
initiating execution of a fourth execution process of the second processing system within the computing system, the fourth execution process being associated with the fourth software logic, the fourth software logic being provided for processing one or more second processed data streams.

34. The method of claim 31 further comprising storing the second hardware logic in one or more memories, the one or more memories being provided in a database and managing the second hardware logic in the database.

35. The method of claim 31 wherein the second hardware logic is compatible with the one or more security logic processors of the security device.

36. The method of claim 31 further comprising processing the second hardware logic using an integrity process.

37. The method of claim 31 wherein the second computing system logic is compatible with a computing system.

38. The method of claim 31 further comprising processing the second computing system logic using an integrity process.

39. A method for upgrading one or more security applications, the method comprising:
providing a computing system coupled to one or more computer networks, the computing system comprising:
a central processing unit, the central processing unit being adapted to oversee one or more instructions associated with the computing system;
a common bus coupled to the central processing unit;
one or more first memory devices coupled to the common bus; a security device coupled to the common bus, the security device coupled to an input/output port coupled to the one or more computer networks, the security device being adapted to process a stream of information derived from the input/output port to perform a pattern matching process on one or more portions of the stream of information at about network speeds;
one or more second memory devices coupled to the security device;
one or more security logic processors coupled to the security device, the one or more security logic processors coupled to the one or more second memory devices, the one or more security logic processors comprising one or more respective first hardware logic,
operating the computing system including the security device coupled to the one or more computer networks;
transferring an FPGA image representative of at least a second hardware logic through the computer network to the one or more first memory devices;
pausing one or more of the security logic processors at a predetermined portion of the stream of information; and
loading the second hardware logic onto the one or more security logic processors while the one or more security logic processors have been paused.

40. The method of claim 39 wherein the common bus includes a PCI bus.

41. The method of claim 39 wherein the stream of information comprises one or more packets.

42. The method of claim 39 wherein the stream of information comprises content data derived from one or more packets.

43. The method of claim 39 wherein about network speed is at least one hundred Megabits per second.

44. The method of claim 39 wherein the security device is adapted to process one or more packets in the stream of information.

45. The method of claim 39 wherein the security device is adapted to process content data derived from one or more packets in the stream of information.

46. The method of claim 39 wherein the one or more first memory devices comprises a fixed storage device.

47. The method of claim 39 wherein the security device comprises the one or more second memory devices coupled to the security device and the one or more security logic processors coupled to the security device, the one or more security logic processors comprising one or more respective first hardware logic.

48. The method of claim 39 wherein the second hardware logic is derived from a security knowledge base coupled to the one or more computer networks.

49. The method of claim 39 further comprising resuming operation of the one or more security logic processors, the one or more security logic processors including the second hardware logic.

50. A method for upgrading one or more security applications, the method comprising:
deriving a second hardware logic from a security knowledge base;
operating a computing system including a security device, the computer system being coupled to the one or more computer networks, the security device comprising one or more security logic processors, the one or more security logic processors comprising one or more respective first hardware logic;
transferring an FPGA image representative of at least the second hardware logic through the computer network to one or more first memory devices, the one or more first memory devices being provided in the computing system;
temporarily halting one or more of the security logic processors at a predetermined portion of the stream of information; and
loading the second hardware logic onto the one or more security logic processors while the one or more security logic processors have been paused; and
resuming the operation of the one or more security logic processors.

51. A system for upgrading one or more security applications, the system comprising one or more computer memories, the one or more computer memories including at least:
one or more codes directed to operating a computing system including a security device, the computer system being coupled to the one or more computer networks, the security device comprising one or more security logic processors, the one or more security logic processors comprising one or more respective first hardware logic;
one or more codes directed to transferring an FPGA image representative of at least a second hardware logic through the computer network to one or more first memory devices, the one or more first memory devices being provided in the computing system;
one or more codes directed to pausing one or more of the security logic processors at a predetermined portion of the stream of information;
one or more codes directed to loading the second hardware logic onto the one or more security logic processors while the one or more security logic processors have been paused; and
one or more codes directed to resuming the operation of the one or more security logic processors.

52. The system of claim 51 wherein the one or more computer memories including at least:
one or more codes directed to operating a first processing system provided in the computing system, the first processing system comprising a first software logic;
one or more codes directed to operating a second processing system provided in the computing system, the second processing system comprising a third software logic;
one or more codes directed to loading a second software logic onto the first processing system to replace at least in part the first software logic; and
one or more codes directed to loading a fourth software logic onto the second processing system to replace at least in part the third software logic.
